(19) United States
(12) Patent Application Publication
(10) Pub. No.: US 2018/0375273 A1
(43) Pub. Date: Dec. 27, 2018

(54) SWITCHED OUTLET SYSTEM AND METHOD

(71) Applicant: Ecolink Intelligent Technology, Inc., Carlsbad, CA (US)

(72) Inventors: Brandon Gruber, San Marcos, CA (US); Michael Bailey, Carlsbad, CA (US)

(21) Appl. No.: 15/634,239

(22) Filed: Jun. 27, 2017

(51) Int. Cl. H01R 33/945; H02J 3/10; H01R 33/06; H01R 13/70

(52) U.S. Cl. CPC H01R 33/945; H01R 13/70; H01R 33/06; H02J 3/10

(57) ABSTRACT

A method, performed by a transmit module coupled to a switched outlet and a receive module coupled to a continuously-powered outlet, for providing switched power to an electrical device from the continuously-powered electrical outlet, comprising detecting, by the transmit module, power applied to the switched outlet as a result of a switch being placed into an “on” position, in response to detecting the power applied to the switched outlet, transmitting, by the transmit module, a first signal to the receive module, receiving, by the receive module, the first signal, and in response to receiving the first signal, causing a switch to apply power to the electrical device from the continuously-powered electrical outlet.

### BACKGROUND

### I. Field of Use

The present application relates to the field of home electrical devices. More specifically, the present application relates to a system and method for providing switched power to an electrical device from a continuously-powered electrical outlet.

### II. Description of the Related Art

Millions of homes have been constructed in the United States over the past several decades that include electrical outlets, also referred to as electrical sockets. Electrical outlets are devices that allow electrically operated equipment to be connected to an alternating current (AC) power supply in a building. Electrical outlets differ in voltage and current ratings, shape, size and types of connectors. The types used in each country are set by national standards, some of which are listed in the IEC technical report TR 60083 Plugs and socket-outlets for domestic and similar general use standardized in member countries of IEC.

Electrical outlets for single phase domestic, commercial and light industrial purposes generally provide either two or three electrical connections to the supply conductors. Two-pin sockets normally provide neutral and line connections, both of which carry current and are defined as live parts. Neutral is usually very near to earth potential, usually being earthed either at the distribution board or at the substation. Line (also known as phase or hot, and commonly, but technically incorrectly, as live) carries the full supply voltage relative to the neutral (and to earth). Three-pin sockets provide, in addition, a protective earth connection for exposed metal parts of an appliance. If internal insulation should fail, a short-circuit to the earthed exposed metal parts will hold them at a low potential, and should operate fuses or circuit breakers to isolate the faulty appliance from the supply. Depending on the supply system, some sockets may have two line connections, each at significant voltage to earth and without a neutral pin; for example, a split phase system may have 240 V between line connections each at 120 V with respect to earth ground; but a single-phase receptacle connected to a three-phase system may have, for example, 208 V between contacts and only 120 V between each contact and earth ground.

While many home electrical outlets are always energized, others may be wired to become energized only when an associated wall switch is activated. Such an outlet is referred to herein as a “switched outlet”. Typically, a toggle switch is placed near an entry door of a room and wired to activate a particular outlet in the room. This arrangement is advantageous when the outlet selected for control by the switch is in a location where, for example, a lamp may be plugged in, allowing a user to light the room simply by activating the switch as the user enters the room. However, more often than not, the switched outlet is not in an area of the room where it is convenient to locate a plug-in electrical lamp. In this case, the benefit of having a switch near the entry door is defeated.

### SUMMARY

The embodiments described herein relate to various embodiments of a system and method for providing switched power to an electrical device from a continuously-powered electrical outlet. In one embodiment, a system is described, comprising system for providing switched power to an electrical device from a continuously-powered electrical outlet, comprising a transmit module coupled to a switched outlet for detecting the presence or absence of power from the switched outlet, and for transmitting a first signal upon detection of the presence of power and a second signal upon detection of the absence of power, and a receive module coupled to the continuously-powered electrical outlet in the same room as the switched outlet, the receive module comprising a plug for coupling the receiver module to the continuously-powered electrical outlet, a socket for providing switched power to an electrical device, a receiver for receiving the first and second signals; and first circuitry configured to receive power from the plug, to provide the power from the plug to the socket upon receipt of the first signal and for removing the power from the socket upon receiving the second signal.

In another embodiment, a method is described, performed by a transmit module coupled to a switched outlet and a receive module coupled to a continuously-powered outlet, for providing switched power to an electrical device from the continuously-powered electrical outlet, comprising detecting, by the transmit module, power applied to the switched outlet as a result of a switch being placed into an “on” position, in response to detecting the power applied to the switched outlet, transmitting, by the transmit module, a first signal to the receive module, receiving, by the receive module, the first signal, and in response to receiving the first signal, causing a switch to apply power to the electrical device from the continuously-powered electrical outlet.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a perspective view of a room in a residential setting, featuring a transmit module and a receive module in accordance with the teachings herein;

FIG. 2 is a perspective view of one embodiment of the transmit module as shown in FIG. 1;

FIG. 3 is a perspective view of one embodiment of the receive module as shown in FIG. 1;

FIG. 4 is a functional block diagram of one embodiment of transmit module as shown in FIGS. 1 and 2;

FIG. 5 is a functional block diagram of one embodiment of receive module as shown in FIGS. 1 and 2;

FIG. 6 is a functional block diagram of another embodiment of a transmit module;

FIG. 7 is an illustration of another embodiment of the transmit module as shown in FIGS. 1 and 2, comprising discreet components;

FIG. 8 is an illustration of another embodiment of the receive module as shown in FIGS. 1 and 2, comprising discreet components; and

FIG. 9 is a flow diagram illustrating one embodiment of a method performed by the transmit module and the receive module as shown in FIG. 1 to control power to an electrical device via the switch as shown in FIG. 1.

### DETAILED DESCRIPTION

The present application relates to a system for control of an electrical outlet. The system comprises a transmit module plugged into a switched electrical outlet and a receive module plugged into a powered outlet, typically in the same room as the switched electrical outlet. When power is applied to the switched outlet, typically by operating a wall switch in the same room as the switched outlet, the transmit module detects energization of the switched outlet and, in response, transmits a signal to the receive module. The receive module receives the signal from the transmit module and, in response, causes a socket of the receive module to become energized with power from the powered outlet. In this way, any powered outlet in a room can be controlled by the wall switch without having to purchase an after-market light switch or engage the services of an electrician.

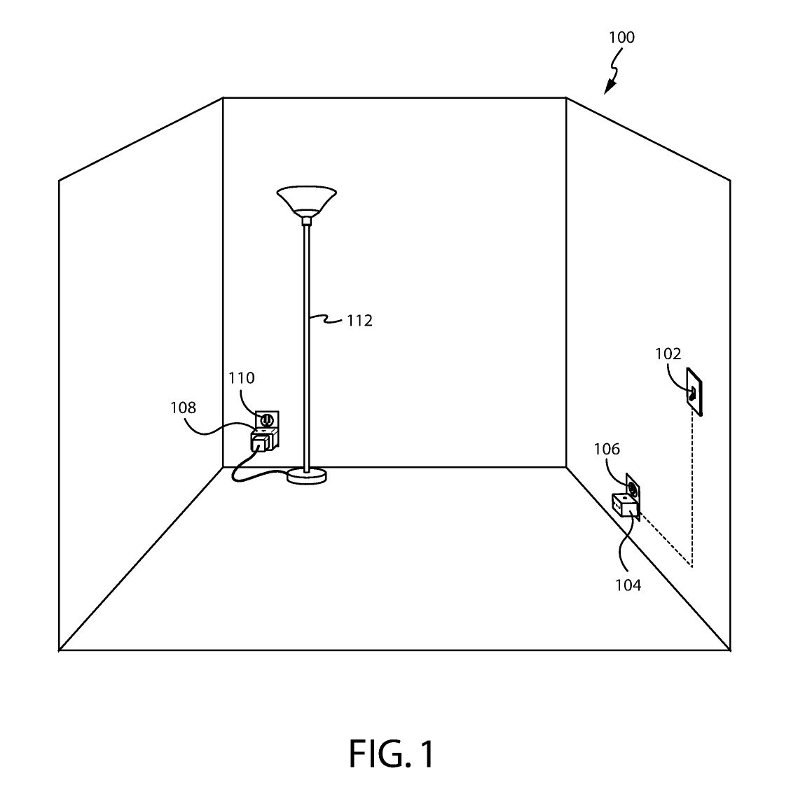

FIG. 1 is a perspective view of a room 100 in a residential setting, comprising wall switch 102, transmit module 104 plugged into switched electrical outlet 106, and receive module 108 plugged into continuously-powered electrical outlet 110. An electrical device 112, shown as a floor lamp, is plugged into receive module 108.

Wall switch 102 comprises any standard, household switch for controlling electrical devices such as lights in a room or, in this case, switched electrical outlet 106. Switched electrical outlet 106. switched electrical outlet 106 is de-energized, un-powered, de-activated, or simply “off” when switch 102 is in a first, “off” position, and energized, powered, activated or “on” when switch 102 is placed into a second “on” position, typically by manipulating a toggle mechanism that forms part of switch 102. When switched electrical outlet 106 is active, household voltage of typically 110-120 VAC is available at switched electrical outlet 106. Typically, switched electrical outlet 106 comprises two outlets, each available for receiving a respective plug from a standard electrical device, such as a light, a toaster, a vacuum cleaner, or any common household appliance, for example. When such an electronic device is plugged into switched electrical outlet 106, the electrical device can be turned “on” or “off” via switch 102, as power is applied and removed from switched electrical outlet 106 as switch 102 is turned on and off.

However, oftentimes, it is desirable for switch 102 to control an outlet other than switched electrical outlet 106. For example, room 100 may be furnished with a bed, a nightstand and a floor lamp for providing light to room 100, where the floor lamp is positioned in proximity to continuously-powered electrical outlet 110. It may be desirable, therefore, to control the floor lamp using switch 102. However, because the floor lamp is located in proximity to continuously-powered electrical outlet 110, it may not be possible or desirable to plug the floor lamp into switched electrical outlet 106, due to the relatively long distance between the two. This problem is solved by the embodiments described herein, as follows.

Transmit module 104 is mechanically and electrically coupled to switched electrical outlet 106, i.e., plugged into switched electrical outlet 106, where it receives power from switched electrical outlet 106 when switch 102 is placed into an “on” position and powered off when switch 102 is placed into an “off” position. Receive module 108 is mechanically and electrically coupled to continuously-powered electrical outlet 110, and electrical device 112 is mechanically and electrically coupled to an outlet provided by receive module 108. Continuously-powered electrical outlet 110 comprises an “always on” electrical outlet and provides continuous 110-120 VAC power to electrical devices. The outlet(s) provided by receive module 108 are normally de-energized, i.e., power is not provided to the outlet(s).

When switch 102 is placed from the “off” position to the “on” position, transmit module 104 becomes energized as a result of switched electrical outlet 106 becoming energized by switch 102. Upon energization, transmit module 104 transmits a signal that is received by receive module 108, either wirelessly, through household wiring that electrically couples switched electrical outlet 106 to continuously-powered electrical outlet 110 (commonly known as “powerline communications”) via switch 102, or both. The signal indicates that switch 102 has been placed into the “on” position and that switched electrical outlet 106 has been energized.

When receive module 108 receives the signal transmitted by transmit module 104, receive module 108 causes power from continuously-powered electrical outlet 110 to be provided to its outlet(s), thereby providing power to electrical device 112. In this way, electrical device 112 may be turned on or off via switch 102, as if electrical device 112 was plugged into switched electrical outlet 106.

Similarly, when switch 102 is placed from the “on” position to the “off” position, transmit module becomes de-energized as a result of switched electrical outlet 106 becoming de-energized by switch 102. However, just before de-energization, transmit module 104 detects the loss of power from switched electrical outlet 106 and in response, transmits a second signal before becoming de-energized. The second signal indicates that switch 102 has been placed into the “off” position and that switched electrical outlet 106 has been de-energized.

When receive module 108 receives the second signal transmitted by transmit module 104, receive module 108 cuts the power from continuously-powered electrical outlet 110 to electrical device 112, turning 112 off.

It should be understood that additional receive modules could be used in room 100, as well as in other rooms or outdoors, in conjunction with a single transmit module 104. For example, upon activation, transmit module 104 can transmit a first “on” signal to receive module 108, turning a light on in room 100, while simultaneously turning on outdoor lighting via a second receive module located in another part of the house, and turn on an amplifier for playing music. In this case, each receive module is generally “paired” with a single transmit module so that only paired receive modules take action when “on” and “off” signals are transmitted by a paired transmit module.

When two or more receive modules are paired with a single transmit module, each receive module may comprise an emitter for transmitting acknowledgement signals to their paired transmit module when they receive “on” and/or “off” signals from a transmit module. Such acknowledgment may be particularly important when controlling electrical devices that are not in room 100, out of sight of a user. In this embodiment, transmit module 104 may comprise one or more indicators, such as LEDs or the like, each assigned to a particular

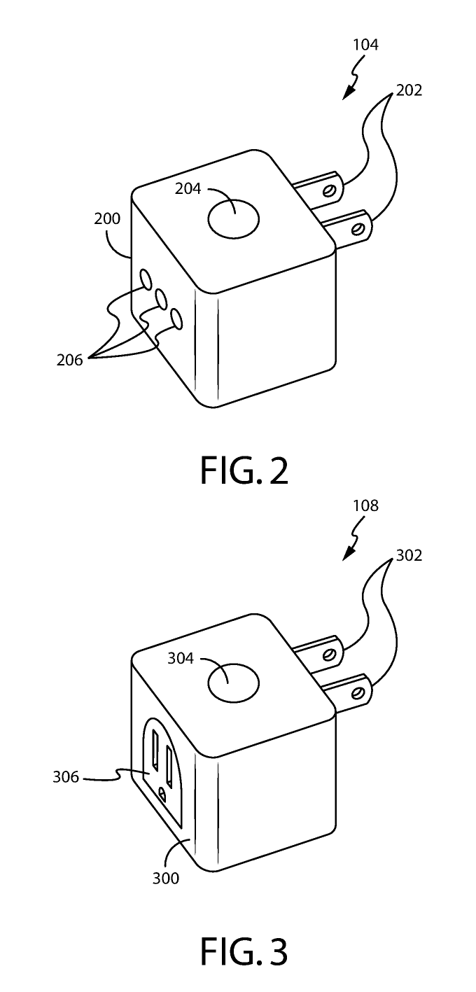

FIG. 2 is a perspective view of one embodiment of transmit module 104. In this embodiment, transmit module 104 comprises a body 200, two electrical prongs 202, a receiver 204, and three LEDs 206 or similar light-emitting devices. Typically, transmit module 104 is designed to small and lightweight so as to not be noticeable when it coupled to switched electrical outlet 106. In one embodiment, body 200 is two inches in width and length, and an inch thick. Prongs 202 comprise two, metal prongs that are sized and shaped to be inserted into a typical, household electrical power outlet, and may be of different size and/or shape to differentiate between neutral and “hot” or power. Prongs 202 may additionally comprise a third metal protrusion, sized and shaped for insertion into a ground receptacle in electrical outlets so equipped. Receiver 204 is an optional feature, comprising a sensor that converts a sensed condition into electrical energy, so that transmit module 104 may determine whether a light was turned on after transmit module 104 transmits a signal to receive module 108, instructing receive module 108 to provide power to electrical device 112. This feature will be described in greater detail herein.

FIG. 3 is a perspective view of one embodiment of receive module 108. In this embodiment, receive module 108 comprises a body 300, two electrical prongs 302, emitter 304 and at least one electrical outlet 306. Typically, receive module 108 is designed to small and lightweight so as to not be noticeable when it coupled to continuously-powered electrical outlet 110. In one embodiment, body 300 is two inches in width and length, and an inch thick. Although these dimensions are the same as transmit module 104, they need not be. Prongs 302 comprise two, metal prongs that are sized and shaped to be inserted into a typical, household electrical power outlet, and may be of different size and/or shape to differentiate between neutral and “hot” or power. Prongs 302 may additionally comprise a third metal protrusion, sized and shaped for insertion into a ground receptacle in electrical outlets so equipped. Emitter 304 is an optional feature, comprising one or more light bulbs, LEDs, IR transmitters, or ultrasonic transducers, designed to send an acknowledgement signal from receive module 108 to transmit module 104 of successful receipt of signals transmitted by transmit module 104. Further details of this feature are described later herein. Electrical outlet 306 mimics a standard electrical outlet, sized and shaped to receive power prongs from electrical device 112, either with or without a ground prong.

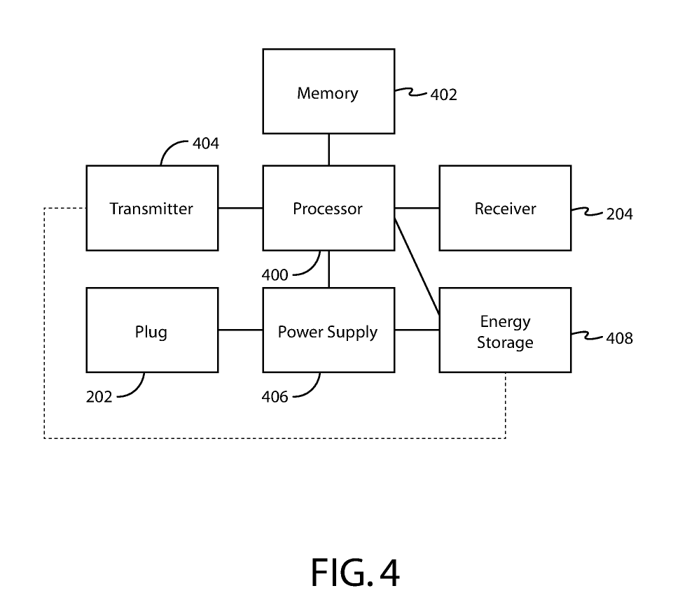

FIG. 4 is a functional block diagram of one embodiment of transmit module 104. Specifically, FIG. 4 shows processor 400, memory 402, receiver 204, transmitter 404, power supply 406, electrical plug 202, energy storage device 408 and LEDs 206. It should be understood that not all of the functional blocks shown in FIG. 4 are required for operation of transmit module 104 (for example, receiver 204), and that the functional blocks may be connected to one another in a variety of ways other than what is shown in FIG. 4.

Processor 400 is configured to provide general operation of transmit module 104 by executing processor-executable instructions stored in memory 402, for example, executable computer code. Processor 400 typically comprises a general purpose microprocessor or microcontroller, manufactured by well-known companies such as Intel Corporation of Santa Clara, Calif., Atmel of San Jose, Calif., and STMicroelectronics based in Geneva, Switzerland, selected based on size, cost and performance characteristics.

Memory 402 comprises one or more information storage devices, such as RAM, ROM, EEPROM, UVPROM, flash memory, SD memory, XD memory, or other type of electronic, optical, or mechanical information storage device. Memory 402 is used to store the processor-executable instructions for operation of transmit module 104 as well as any information used by processor 200, such as information pertaining to whether receive module 108 successfully received one or more transmissions from transmit module 104.

In one embodiment, receiver 204 comprises a light or sound transducer that converts light or sound into electrical energy for use by processor 400. As such, receiver 204 may comprise an IR receiver, a LED receiver, or an ultrasonic receiver. In another embodiment, receiver 204 may comprise an RF receiver or a powerline circuitry to receive and demodulate wireless or wired signals transmitted from transmit module 104. Such circuitry is well known in the art and may comprise BlueTooth, Wi-Fi, RF, or powerline circuitry, among others.

Transmitter 404 comprises circuitry to transmit signals to receive module 108 via RF, IR, ultrasonic, or powerline technology, all of which are well known in the art.

Power supply 406 comprises an AC-to-DC converter for providing low-voltage, DC power to processor 400, memory 402, transmitter 404 and receiver 204. Typically, power supply 406 converts household 110-120 VAC power to 3.3, 5, 12, or some other DC voltage. An input of power supply 406 is mechanically and electrically coupled to one of the prongs 202. Power supply 406 provides DC voltage(s) to the electrical components of transmit module 104 when switched electrical outlet 106 is energized via switch 102. When switched electrical outlet 106 is de-energized via switch 102, the DC voltage(s) provided by power supply 406 are reduced to approximately zero volts over a very short time period, such as 50 milliseconds, but not instantaneously.

Energy storage device 408 is used to store energy from power supply 406 or directly from plug 202 to provide power to the components of transmit module 104 to ensure that at least one signal is transmitted when switched electrical outlet 106 loses power as a result of switch 102 being placed into the “off” position. In this embodiment, charge storage device 408 comprises a capacitor or an inductor. In another embodiment, a rechargeable battery is used. In yet another embodiment, a non-rechargeable battery is used, but is not charged by power supply 406 or plug 202. In an embodiment where energy storage device 408 comprises a capacitor or an inductor, the capacitor or inductor is selected to store enough charge to allow processor 400 to transmit at least one signal to receive module 108 in order for receive module 108 to cut power to electrical device 112.

LEDs 206 comprise one or more light-emitting devices, such as LEDs, LCDs or the like, which provides an inexpensive status of one or more electrical devices that are controlled by transmit module 104. The LEDs are off when transmit module 104 is off, i.e., switch 102 is in an “off” position. Each LED becomes illuminated by processor 400 when processor 400 receives an acknowledgement from each electrical device that it is controlling. For example, if three receive modules have been paired with transmit module 104, processor 400 may assign each one to a particular LED 206. Then, when acknowledgements are received by transmit module 104 after transmitting an “on” signal to the three receive modules, processor 400 causes a corresponding LED to become illuminated. This provides a useful visual indication as to which electrical devices were actually turned on by the “on” signal. When an “off” signal is transmitted by transmit module 104, the LEDs may remain powered by one or more other energy storage devices, such as a capacitor or battery until an “off” acknowledgement is received from the one or more transmit devices, prior to transmit module 104 losing power as a result of switch 102 being placed into the “off” position. In another embodiment, energy storage device 408 is sized to accommodate both transmission of an “off” signal, as well as to process “off” acknowledgement(s) and de-activate the LEDs as acknowledgements are received from the receive modules(s). Although the LEDs will be extinguished after the energy storage device is exhausted, this embodiment will, nevertheless, provide an instant feedback mechanism to a user who has just placed switch 102 into the “off” position.

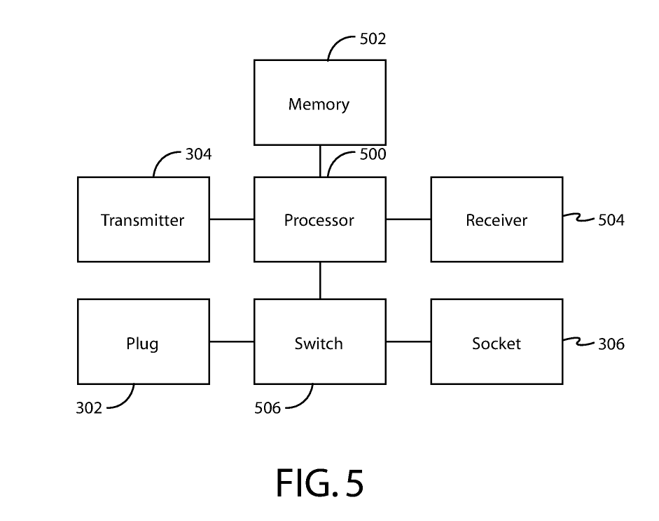

FIG. 5 illustrates a functional block diagram of one embodiment of receive module 108. Specifically, FIG. 5 shows processor 500, memory 502, receiver 504, emitter 304, electrical plug 302, switch 506 and electrical socket 306. It should be understood that not all of the functional blocks shown in FIG. 4 are required for operation of transmit module 104 (for example, receiver 204), and that the functional blocks may be connected to one another in a variety of ways other than what is shown in FIG. 4. No power supply is shown, for purposes of clarity, as the components shown in FIG. 5 may be powered by a power supply similar to power supply 406 or by a rechargeable or non-rechargeable battery, as is well known in the art. In the case of a power supply, unlike power supply 406, power is never switched off at continuously-powered electrical outlet 110. Thus, receive module 108 is continuously powered. Emitter 304, plug 302 and socket 306 have previously been described.

Processor 500 is configured to provide general operation of receive module 108 by executing processor-executable instructions stored in memory 502, for example, executable computer code. Processor 500 typically comprises a general purpose microprocessor or microcontroller, manufactured by well-known companies such as Intel Corporation of Santa Clara, Calif., Atmel of San Jose, Calif., and STMicroelectronics based in Geneva, Switzerland, selected based on size, cost and performance characteristics.

Memory 502 comprises one or more information storage devices, such as RAM, ROM, EEPROM, UVPROM, flash memory, SD memory, XD memory, or other type of electronic, optical, or mechanical information storage device. Memory 502 is used to store the processor-executable instructions for operation of receive module 108 as well as any information used by processor 200, such as information pertaining to whether receive module 108 successfully received one or more transmissions from transmit module 104.

Receiver 504 comprises well-known circuitry for receiving signals transmitted by transmit module 104. Receiver 504 may comprise an RF receiver, an IR receiver, an ultrasonic receiver, a powerline receiver, or some other receive circuitry that is known in the art.

Switch 506 comprises a relay, transistor or other switch that provides power from plug 302 (i.e., 110-120 VAC) to socket 306 and, hence, electrical device 112, upon a signal from processor 500 and, likewise, cuts power to socket 306 upon another signal from processor 500. This process is detailed below.

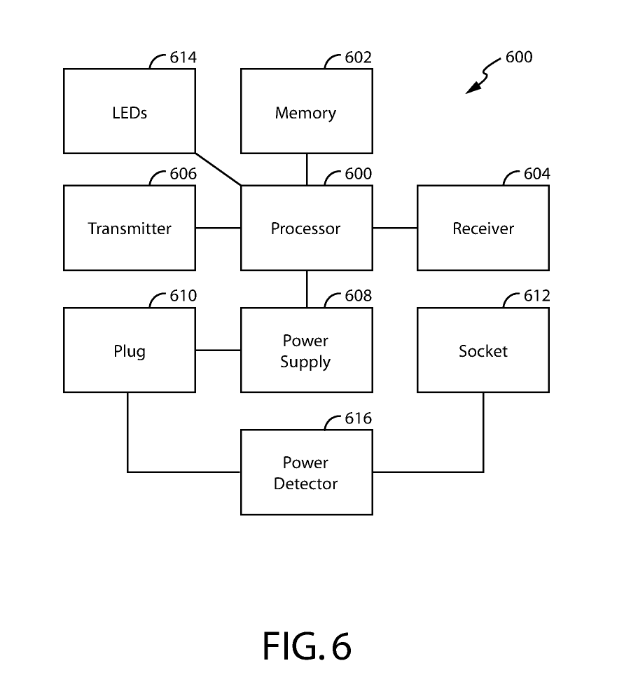

FIG. 6 is a functional block diagram of another embodiment of a transmit module 600. In this embodiment, transmit module 600 is plugged into a continuously powered electrical outlet rather than a switched outlet, and further provides an electrical socket for plugging an electronic device into transmit module 600. When the electrical device that is plugged into transmit module 600 is turned on, transmit module 600 detects that the electrical device has been turned on, as evidenced, for example, by an increase in current draw through transmit module 600, or by some other means. Upon detection that the electrical device has been turned on, transmit module transmits an “on” signal to one or more receive modules, as described previously. When transmit module 600 determines that the electrical device has been turned off, it transmits an “off” signal to the one or more receive modules, also described previously.

FIG. 6 illustrates processor 600, memory 602, receiver 604, transmitter 606, power supply 608, electrical plug 610, electrical socket 612, LEDs 614 and power detector 616. Some or all of these components may be implemented as discreet components, integrated circuits, or a combination of both. It should be understood that not all of the functional blocks shown in FIG. 6 are required for operation of transmit module 600 (for example, receiver 204 or LEDs 608), and that the functional blocks may be connected to one another in a variety of ways other than what is shown in FIG. 6. Processor 600, memory 602, receiver 604, transmitter 606 power supply 608, electrical plug 610, and LEDs 614 are the same or similar to like items shown in FIG. 4 and their descriptions are not repeated here. Electrical socket 612 is similar to electrical outlet 106 on receive module 108.

As shown, power from a continuously-powered outlet is provided via electrical plug 610 to socket 612 for powering one or more electrical devices. Power detector 616 detects when one or these electrical devices has been turned on by a user. In one embodiment, power detector comprises a resistor sized to accommodate 15 or 20 amps of 110-120 VAC power at a relatively low ohm value, such as 1 ohm, for providing a voltage drop that may be measured by processor 600 in order to determine when a sudden increase in current has occurred, for example when an electrical device plugged into socket 612 is turned on. In other embodiments, one or more of transformers, relays, transistors, etc. may be used to provide such a change in current draw, measurable by processor 600. Other ways to determine when an electrical device has been turned on (or off) are well known in the art. In one embodiment, receiver 604 may be used as a feedback mechanism to determine when a light, for example, has been turned on, as explained above with respect to transmit module 104. When processor 600 determines that the electrical device plugged into socket 612 has been turned on, processor 600 causes transmitter 606 to transmit an “on” signal to one or more receive modules, indicating that a user has turned on an electrical device and for the receive modules to apply power to their respective electrical devices. When power detector 616 determines that the electrical device plugged into socket 612 has been turned off, processor 400 causes transmitter 606 to transmit an “off” signal, which causes the one or more receive modules to cut power to their respective electrical devices.

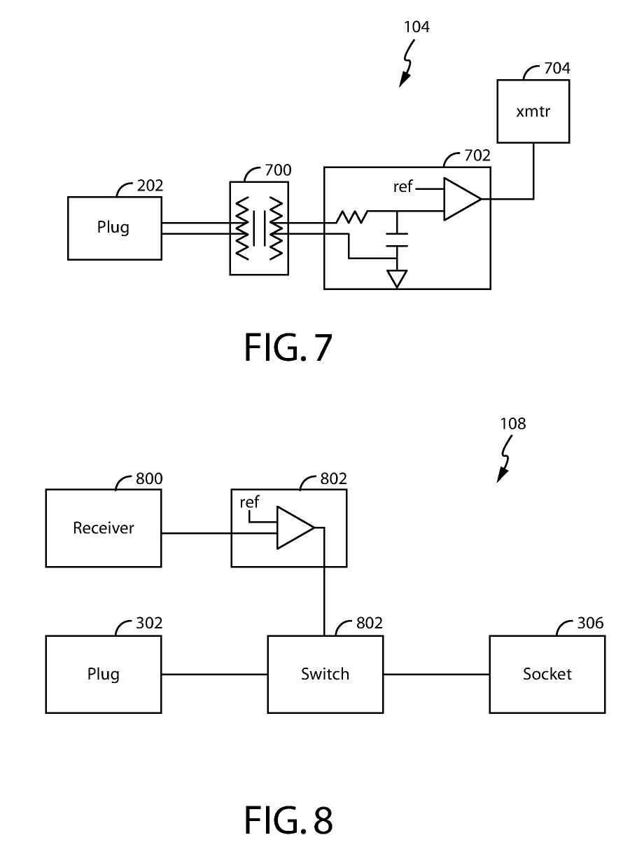

FIG. 7 is an illustration of another embodiment of transmit module 104, comprising discreet components. Plug 202 provides switched power to step-down circuitry 700, typically a transformer that converts the 110-120 VAC from plug 302 to a lower voltage, such as 5-10 VAC. The stepped-down voltage is provided to detection circuitry 702, which determines when switched electrical outlet 106 becomes energized and de-energized as a result of switch 102 being placed into the “on” and “off” positions, respectively. FIG. 6 illustrates one embodiment of such detection circuitry, comprising a low pass filter and comparator that compares the filtered, stepped-down voltage from step-down circuitry 700 and provides a signal to transmitter 704 to transmit the first signal. Transmitter 704 may comprise an integrated circuit specially designed to provide low cost, low power transmitting capabilities. The first signal may comprise a continuous wave signal at a particular, predetermined frequency indicative of switch 102 being turned to the “on” position, a modulated, digital sequence, or some other predetermined waveform indicative of switch 102 begin turned on. When switch 102 is turned “off”, detection circuitry 702 determines the loss of power, again by comparing the voltage from step-down circuitry 700 to the reference voltage, and provides a signal to transmitter 704, causing transmitter 704 to transmit the second signal, which may comprise a different frequency, amplitude, phase or modulated digital sequence than the first signal.

FIG. 8 is an illustration of another embodiment of receive module 108, comprising discreet components. Receiver 800 receives the first and second signals transmitted by transmit module 104, demodulates the signals, and provides an output to detection circuitry 802, in this example, a simple comparator circuit. In this embodiment, when the first signal is received, receiver 800 provides a signal to detection circuitry, for example a fixed voltage. Detection circuitry 802 detects the voltage from receiver 800 and provides a voltage to switch 804, for example, a transistor or relay, which causes switch 804 to close, providing power to socket 306. When receiver 800 receives the second signal, receiver 700 may provide a different voltage to detector 802, and detector 802 detects this voltage and provides another voltage to switch 804, causing switch 804 to cut power to socket 306.

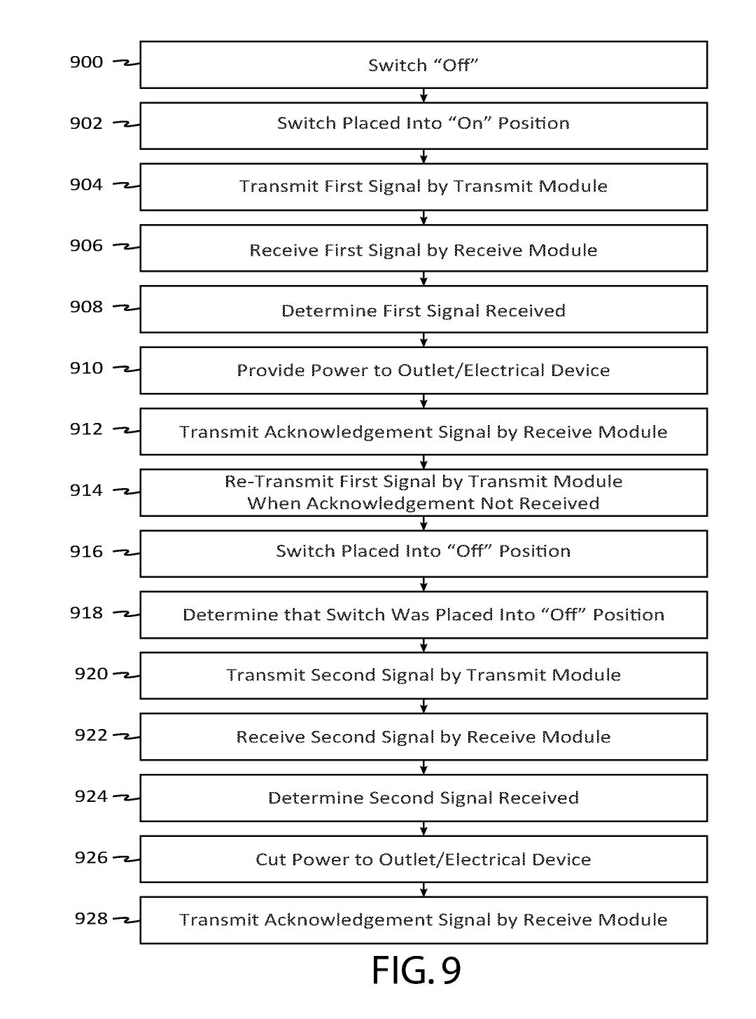

FIG. 9 is a flow diagram illustrating one embodiment of a method performed by transmit module 104 and receive module 108 to control power to electrical device 112 via switch 102. It should be understood that in some embodiments, not all of the steps shown in FIG. 9 are performed. It should also be understood that the order in which the steps are carried out may be different in other embodiments. The method is performed in accordance with the configuration shown in FIG. 1, with transmit module 104 plugged into switched electrical outlet 106, receive module 108 plugged into continuously-powered electrical outlet 110, and electrical device 112 plugged into receive module 108. It should also be understood that although the method refers to transmit module 104 and receive module 108 in the embodiments shown in FIGS. 4 and 5, respectively, the steps could alternatively be performed by the discrete components shown in FIGS. 6 and 7.

At block 900, switch 102 is in an “off” position, and no power is present at switched electrical outlet 106. Transmit module 104 is powered off due to the lack of power from switched electrical outlet 106.

At block 902, switch 102 is placed into an “on” position by a user. As a result, switched electrical outlet 106 becomes energized with 110-120 VAC, and transmit module 104 is powered on from the power supplied by switched electrical outlet 106 and power supply 406.

At block 904, in response to being powered on, processor 400 causes transmitter 404 to transmit a first signal to receive module 108. In another embodiment, the first signal is transmitted in response to processor 400 determining that power has been applied to switched electrical outlet 106. This embodiment is used when transmit module 104 is powered by a battery and does not rely on switched electrical outlet 106 for operational power. The first signal indicates that switch 102 was placed into the “on” position, and for receive module 108 to provide power from continuously-powered electrical outlet 110 to electrical device 112. The first signal may comprise one or more digital packets having an identification code that uniquely identifies receive module 108. Such an identification code could be generated using a “pairing process” between receive module 108 and transmit module 104, as well-known in the art. The identification code is used to ensure that the first signal controls only transmit module 104 that is located in the same room as transmit module 104, so that other transmit module 104's that may be installed in other rooms are not influenced by the first signal transmitted by transmit module 104.

The first signal may further comprise a predetermined digital sequence, indicative of switch 102 being placed into the “on” position. In another embodiment, the first signal may comprise, simply, a modulated or unmodulated sinusoidal waveform, transmitted using well-known RF techniques such as frequency modulation or amplitude modulation.

In another embodiment, processor 400 does not transmit the first signal as soon as power is applied to switched electrical outlet 106. Rather, transmission is delayed until energy storage device 408 is sufficiently powered to additionally transmit a second signal, instructing receiver 108 to cut power to electrical device 112. This embodiment is useful to prevent a condition where switch 102 is turned from “off” to “on” and then back to “off” very quickly. Without a delay, processor 400 may cause transmission of the first signal, but unable to transmit the second, “turn off” signal if energy storage device had not had time to charge to the point of being capable of powering processor 400 and/or transmitter 404 sufficiently to transmit the second signal. The delay is typically set to avoid a perceptible delay between turning switch 102 “on” and when electrical device 112 becomes activated, but enough to power at least processor 400 and/or transmitter 404 sufficiently to transmit the second signal. In one embodiment, a hardware or software counter is used to enable transmission a predetermined time after electrical switched outlet 106 becomes energized, such as 200 milliseconds. In another embodiment, one or more discreet components may be used, such as a capacitor and resistor combination, where the capacitor becomes sufficiently charged after 200 milliseconds of applied power. Other embodiments are well known to those skilled in the art.

At block 906, the first signal is received by receive module 108, via receiver 504, demodulated and provided to processor 500.

At block 908, processor 500 determines that the first signal was received. In one embodiment, processor 500 compares a digital sequence in the first signal and compares the digital sequence to a representative digital sequence stored in memory 502, indicating that switch 102 has been placed into the “on” position. If a match is determined, processor 500 determines that the first signal was received.

At block 910, in response to determining that the first signal was received, processor 500 causes switch 506 to close, allowing power from plug 302 to be provided to socket 306, thus energizing socket 306 and, thus, electrical device 112.

At block 912, in one embodiment, also in response to determining that the first signal was received, processor 500 causes emitter 304 to transmit an acknowledgement to transmit module 104, indicating successful receipt of the first signal. The acknowledgment signal may comprise one or more digital packets having an identification code that uniquely identifies transmit module 104, from the pairing process mentioned earlier. In one embodiment, emitter 304 comprises an infra-red (IR) transmitter and transmit module 104 receives the acknowledgement signal via receiver 504, in this case, an IR receiver.

At block 914, if processor 400 fails to receive the acknowledgement signal transmitted by transmit module 104 at block 912 within a predetermined time period, such as 1 second, processor 400 may cause transmitter 404 to re-transmit the first signal at least one more time. In another embodiment, processor 400 causes transmitter 404 to re-transmit the first signal until the acknowledgement signal is received.

In another embodiment, where receive module 108 does not transmit an acknowledgement signal (i.e., receive module 108 is not configured with emitter 304), acknowledgement of whether the first signal was received successfully may be determined by processor 400, via receiver 204, receiving light from electrical device 112. This feature may be useful when a room is dim or dark, and receive module 108 is used to control a light source. In this embodiment, receiver 406 is sensitive to visible light from electrical device 112, and when light is received by receiver 204 from electrical device 112, processor 400 determines that the first signal was successfully received by receive module 108. If processor 400 fails to receive a signal from receiver 204, indicating reception of light from electrical device 112, processor 400 may re-transmit the first signal one or more times, until such signal is received from receiver 204, indicating that electrical device 112 was turned on.

At block 916, switch 102 is placed into an “off” position by a user, causing switched electrical outlet 106 to become de-energized.

At block 918, processor 400 detects a reduction in the voltage from power supply 406 or directly from switched electrical outlet 106 via plug 202. Processor determines that switch 102 was placed into the “off” position when the voltage from switched electrical outlet 106 or power supply 406 drops by a predetermined threshold, such as when the voltage from switched electrical outlet 106 or power supply 406 drops by 30%.

At block 920, in response to determining that switch 102 has been placed into the “off” position, processor 400 causes transmitter 404 to transmit a second signal indicating that switch 102 has been placed into the “off” position. The second signal may comprise a different digital sequence than the first signal, or it may be the same. If the same, processor 500 simply toggles switch 506 each time that a signal is received. In one embodiment, energy storage device 408 provides enough residual power to at least processor 400 and transmitter 404 in order for processor 400 to cause transmitter 404 to transmit the second signal.

At block 922, the second signal is received by receive module 108, via receiver 504, demodulated and provided to processor 500.

At block 924, processor 500 determines that the second signal was received. In one embodiment, processor 500 compares a digital sequence in the second signal and compares the digital sequence to a representative digital sequence stored in memory 502, indicating that switch 102 has been placed into the “off” position. If a match is determined, processor 500 determines that the second signal was received.

At block 926, in response to determining that the second signal was received, processor 500 cuts the power from plug 302 to socket 306, i.e., causes switch 506 to open, de-energizing socket 306 and, thus, electrical device 112.

At block 928, in one embodiment, also in response to determining that the second signal was received, processor 500 causes emitter 304 to transmit an acknowledgement to transmit module 104, indicating successful receipt of the second signal. The acknowledgment signal may comprise one or more digital packets the same as the acknowledgement signal sent at block 912, or it may be different.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A system for providing switched power to an electrical device from a continuously-powered electrical outlet, comprising:
a transmit module coupled to a switched outlet for detecting the presence or absence of power from the switched outlet, and for transmitting a first signal upon detection of the presence of power and a second signal upon detection of the absence of power; and
a receive module coupled to the continuously-powered electrical outlet in the same room as the switched outlet, the receive module comprising:
a plug for coupling the receiver module to the continuously-powered electrical outlet;
a socket for providing switched power to an electrical device;
a receiver for receiving the first and second signals; and
first circuitry configured to receive power from the plug, to provide the power from the plug to the socket upon receipt of the first signal and for removing the power from the socket upon receiving the second signal.

2. The system of claim 1, wherein the transmit module comprises:
a plug for plugging the transmit module into the switched outlet and for receiving power from the switched outlet;
a transmitter coupled to the second circuitry for transmitting the first and second signals; and
second circuitry coupled to the plug and the transmitter, configured to detect the presence and absence of power from the switched outlet via the plug and, in response, transmit the first or second signal.

3. The system of claim 2, further comprising:
an energy storage device for storing a quantity of electrical energy from the switched outlet, the quantity of electrical energy at least enough to transmit the second signal after the switched outlet becomes de-energized.

4. The system of claim 3, where the energy storage device comprises a capacitor.

5. The system of claim 2, wherein the transmitter and the second circuitry are powered by the power from the switched outlet when the switched outlet is energized.

6. The system of claim 5, wherein the transmitter and the second circuitry are de-powered when the switched outlet is de-energized, and the second signal is transmitted just prior to the transmitter becoming de-energized after the switched outlet becomes de-energized.

7. The system of claim 2, further comprising:
an infra-red transmitter coupled to the first circuitry, wherein the first circuitry causes the infra-red transmitter to transmit an acknowledgement signal indicative of the receive module receiving the first signal from the transmit module; and
an infra-red receiver coupled to the second circuitry; wherein the circuitry causes the transmitter to re-transmit the first signal when the circuitry fails to receive the acknowledgment signal after transmitting the first signal.

8. The system of claim 1, wherein the transmit module further comprises:
a light detector coupled to the circuitry for detecting the presence or absence of light from the electrical device; and
wherein the circuitry causes the transmitter to re-transmit the first signal at least a second time if the light detector indicates the absence of light after the first signal is initially transmitted.

9. A method, performed by a transmit module coupled to a switched outlet and a receive module coupled to a continuously-powered outlet, for providing switched power to an electrical device from the continuously-powered electrical outlet, comprising:
detecting, by the transmit module, power applied to the switched outlet as a result of a switch being placed into an “on” position;
in response to detecting the power applied to the switched outlet, transmitting, by the transmit module, a first signal to the receive module;
receiving, by the receive module, the first signal; and
in response to receiving the first signal, causing a switch to apply power to the electrical device from the continuously-powered electrical outlet.

10. The method of claim 9, further comprising:
detecting, by the transmit module, power removed from the switched outlet as a result of the switch being placed into an “off” position;
in response to detecting the power removed from the switched outlet, transmitting, by the transmit module, a second signal to the receive module;
receiving, by the receive module, the second signal; and
in response to receiving the second signal, causing the switch to cut power from to the electrical device from the continuously-powered electrical outlet.

11. The method of claim 10, further comprising:
providing power to the transmit module from the switched outlet when power is applied to the switched outlet; and
providing power to the transmit module from an energy storage device for a predetermined time period after the power is removed from the switched outlet.

12. The method of claim 10, further comprising:
transmitting, by the receive module, an acknowledgment signal to the transmit module in response to receiving the first signal.

13. The method of claim 12, further comprising:
re-transmitting, by the transmit module, the first signal when the transmit module fails to receive the acknowledgement signal within a predetermined time period from originally transmitting the first signal.

14. The method of claim 10, further comprising:
receiving, by the transmit module, light produced by the electrical device after transmission of the first signal; and
re-transmitting, by the transmit module, the first signal when the transmit module fails to receive the light within a predetermined time period from originally transmitting the first signal.

15. The method of claim 11, wherein transmitting the first signal occurs when power has been removed from the switched outlet and the transmit module is powered by the energy storage device.
